(19) United States
(12) Patent Application Publication
(10) Pub. No.: US 2012/0298737 A1
(43) Pub. Date: Nov. 29, 2012

(54) METHODS, APPARATUSES AND ARTICLES OF MANUFACTURE TO PROVIDE PASSENGER PREFERENCE DATA TO IN-FLIGHT ENTERTAINMENT SYSTEMS

(75) Inventors: Chetan Yogendra Thakar, Torrance, CA (US); Christopher K. Mondragon, Laguna Niguel, CA (US); Kenneth A. Brady, JR., Trabuco Canyon, CA (US)

(73) Assignee: Thales Avionics, Inc., Irvine, CA (US)

(21) Appl. No.: 13/156,467

(22) Filed: Jun. 9, 2011

Related U.S. Application Data
(60) Provisional application No. 61/490,467, filed on May 26, 2011.

(51) Int. Cl. G06F 17/40

(52) U.S. Cl. 235/375

(57) ABSTRACT

Methods, apparatuses and articles of manufacture to provide passenger preference data to in-flight entertainment systems are disclosed. A disclosed example airline passenger seat includes an optical device to optically scan a barcode presented by a passenger associated with the airline passenger seat, the barcode generated by the passenger and including a representation of passenger preference data, a display device to enable the passenger to review the passenger preference data, and a communication module to provide the passenger preference data to an in-flight entertainment system.

### CROSS-REFERENCE TO RELATED APPLICATION

This application claims the priority of U.S. Provisional Application No. 61/490,467, entitled “Methods, Apparatuses and Articles of Manufacture to Provide Passenger Preference Data to In-Flight Entertainment Systems,” and filed on May 26, 2011, the entirety of which is hereby incorporated by reference.

### BACKGROUND

1. Field of the Disclosure

This disclosure relates generally to passenger service systems, including in-flight entertainment systems, and, more particularly, to methods, apparatuses and articles of manufacture to provide passenger preference data to in-flight entertainment systems.

2. Description of the Related Art

There are a wide range of uses for passenger preference data and passenger-specific information in the operation of a commercial aircraft. Example uses include the delivery of special meals, the identification of important passengers, the support of more personalized service by cabin crew, etc. Today, for the vast majority of airlines, this is a physical process of printing and carrying onto the aircraft paper records with this information. Separate forms are typically used for each type of service. For example, the passenger manifest identifies the passengers, their anticipated seat location and any special status they may have with the airline. A separate catering report identifies people who have requested special meals. Such paper passenger preference data and passenger specific information records may be ineffective and inflexible.

Many itineraries include multiple flight segments on different aircraft. It may be desirable for a passenger to be able to view such itineraries as one long flight with seamless services provided across the multiple segments. To accomplish this, passenger-specific information and passenger preference data from one flight needs to be available on subsequent flights. For example, a passenger may have watched part of two movies and created a detailed playlist of audio programs during one flight segment. The passenger may want to continue watching the movies or listen to the audio programs on subsequent flight segments. While today's in-flight entertainment systems are capable of collecting and providing this “state” information during a flight, there are currently no methods of moving this data to subsequent flights.

### SUMMARY

Example methods, apparatuses and articles of manufacture to provide passenger preference data to in-flight entertainment systems are disclosed herein. As used herein, an in-flight entertainment system refers to any system by which services such as food, drink, audio, video, Internet, etc. are provided to passengers during a flight. In general, passenger generated and controlled barcodes are used to provide passenger preference data to in-flight entertainment systems and to transfer passenger preference data between in-flight entertainment systems of different aircraft. Privacy is substantially increased by having the passenger control, choose or select what information is included in a particular barcode and decide whether to scan a barcode. Compared to present and previously contemplated systems, numerous advantages are realized by the use of barcodes or other easily reproducible, graphical, symbolic, optically viewable, and portable medium to convey passenger preference data or passenger-specific information. For example, there is inherent device independence, barcodes are highly mobile and compact, and, because the barcode is machine-readable only (i.e., not understandable by humans), there is inherent security and privacy, etc. As disclosed herein, a passenger may generate a barcode from any location at which they can access a barcode generator or a barcode server via, for example, the Internet.

A disclosed example method includes operating a user interface to enable a passenger to generate a barcode including a representation of passenger preference data, and operating an in-flight entertainment system in an airplane to enable the passenger to optically scan the barcode to provide the passenger preference data to the in-flight entertainment system.

A disclosed example system includes a server to enable a passenger to generate a barcode including a representation of passenger preference data, and an in-flight entertainment system including a scanner to enable the passenger to optically scan the barcode to provide the passenger preference data to the in-flight entertainment system.

A disclosed example apparatus includes a user interface to enable an airline passenger to provide passenger preference data, and a barcode generator to generate a barcode including a representation of the passenger preference data, the barcode optically scannable by the passenger within an airplane to provide the passenger preference data to an in-flight entertainment system of the airplane.

Another disclosed example method includes presenting a user interface to enable an airline passenger to provide passenger preference data, and generating a barcode including a representation of the passenger preference data, the barcode optically scannable by the passenger within an airplane to provide the passenger preference data to an in-flight entertainment system of the airplane.

A disclosed example tangible article of manufacture stores machine-readable instructions that, when executed, cause a machine to at least present a user interface to enable an airline passenger to provide passenger preference data, and

generate a barcode including a representation of the passenger preference data, the barcode optically scannable by the passenger within an airplane to provide the passenger preference data to an in-flight entertainment system of the airplane.

A disclosed example airline passenger seat includes an optical device to optically scan a barcode presented by a passenger associated with the airline passenger seat, the barcode generated by the passenger and including a representation of passenger preference data, a display device to enable the passenger to review the passenger preference data, and a communication module to provide the passenger preference data to an in-flight entertainment system.

Yet another disclosed example method includes optically scanning at a passenger seat a barcode presented by a passenger associated with the passenger seat, the barcode generated by the passenger and including a representation of passenger preference data, presenting a user interface to enable the passenger to review the passenger preference data, and communicating the passenger preference data to an in-flight entertainment system.

Another disclosed example article of manufacture stores machine-readable instructions that, when executed, cause a machine to at least optically scan at a passenger seat a barcode presented by a passenger associated with the passenger seat, the barcode generated by the passenger and including a representation of passenger preference data, present a user interface to enable the passenger to review the passenger preference data, and communicate the passenger preference data to an in-flight entertainment system.

### BRIEF DESCRIPTION OF THE DRAWINGS

The above and other features and advantages will become more apparent by describing in detail exemplary embodiments with reference to the attached drawings in which:

FIG. 1 is a block diagram that schematically illustrates of an example system to provide passenger preference data to in-flight entertainment systems;

FIG. 2 is a pictorial perspective diagram that illustrates an example implementation of the example in-flight entertainment console of FIG. 1;

FIG. 3 is a data structure diagram that illustrates example passenger preference data that may be included in a barcode;

FIG. 4 is a flowchart illustrating an example process that may be carried out to implement the example barcode server of FIG. 1; and

FIGS. 5 and 6 are flowcharts illustrating example processes that may be carried out to implement the example in-flight entertainment console of FIG.

### DETAILED DESCRIPTION

Currently, airlines are investigating methods by which passenger information can be electronically communicated to aircraft. Methods being investigated include bringing an electronic device such as a universal serial bus (USB) memory stick loaded with the information to the aircraft just prior to departure, maintaining an on-board database of customer data, and at-the-gate communication systems between the aircraft and the ground over which this information could be transferred.

The use of a USB memory stick to electronically transfer passenger data may be as problematic as current paper processes. Such methods require the passenger data to be obtained, consolidated, and stored on the USB memory stick at each boarding gate. The USB memory stick has to be removed and moved onto the aircraft as the gate is closing. However, it does permit the data to be electronically loaded into the aircraft systems for more effective use during the flight.

It is possible for some systems to permit information such as playlists and movie positions to be stored on a USB memory stick provided by a passenger. This information could then be transferred to the in-flight entertainment system on a subsequent flight. While technically feasible, the logistics of requiring a passenger to carry a USB memory stick compatible with the in-flight entertainment system, inserting it at a proper time toward the end of the first flight segment, and again inserting it into the seat of a subsequent flight may be difficult to manage.

Airlines could provide their high-value passengers with USB memory sticks specifically for the purpose of storing and transfer personal information into and between aircraft. This requires the airline to invest in the USB memory sticks, replace the USB memory sticks when they are lost or misplaced, and impose on the passenger to remember to carry and use this device for this purpose.

The use of at-the-gate communication systems can avoid the effort and logistically issues associated with the use of USB memory sticks. It also permits the data to be quickly and electronically transferred to the aircraft systems for more effective use during the flight. However, it requires each airport or airport gate to be fitted with communication equipment compatible with the aircraft. If an airport does not have the communication equipment, the enhanced features would not be available to the passengers and crew. Additionally, the aircraft must be fitted with communication equipment capable of operating at each location the aircraft lands. For short-range aircraft running domestic routes this may not be a serious problem but for long-range international carriers this may be problematic because of inconsistent regulations and technologies used internationally for wireless communication. Moreover, depending on the communication technologies available at a particular airport, the amount of passenger information that can be transferred may be restricted due to the transfer speed and time at the gate.

Airlines that operate in an “inbound/outbound” manner from hub locations could attempt to load multiple flights worth of information at the major hubs, thus, only needing modifications at the major hubs. However, passenger information (e.g., seat location) can be dynamic and the earlier it is collected, the less useful it becomes.

Any of the approaches where the airline systems collect, track and transfer information to the aircraft are also subject to passenger privacy concerns. For example, how is the data obtained, where is it stored, who has access to the data, how can the passenger effect removal of data from the airlines systems may be issues of concern to passengers. These issues may represent legitimate passenger concerns that may place an airline in a compromised position when dealing with passengers. The more apparent it is that the airline is collecting, distributing, and using data specific to each passenger, the more difficulty the airline may have with passenger complaints and potential legal action.

Further, the physical and manual data transfers described above may create additional work for airline employees (e.g., cabin crew, maintenance workers, gate agents, etc.). Moreover, electronic data transfer methods may be cost prohibitive in many instances because of the needed airline information technology infrastructure and airport wireless infrastructure.

Apparatuses, methods and articles of manufacture to provide passenger preference data to in-flight entertainment systems that overcome at least the above problems are disclosed herein.

Exemplary embodiments will now be described more fully with reference to the accompanying drawings.

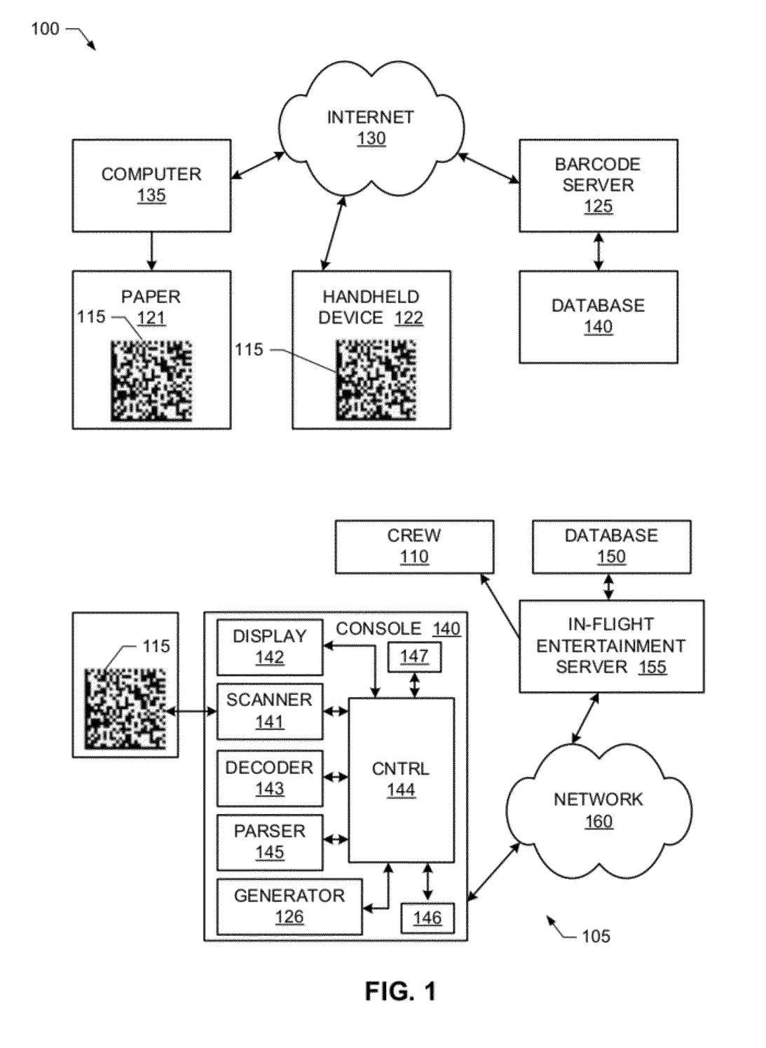

FIG. 1 illustrates an example system 100 that may be used by a passenger to provide passenger preference data or passenger-specific information to in-flight entertainment systems, one of which is designated at reference numeral 105 and crew members 110 of an aircraft. Moreover, the system 100 may be used by the passenger to transfer passenger preference data or passenger-specific information between in-flight entertainment systems of different aircraft.

As described in detail below, passenger preference data or passenger-specific information is provided to the in-flight entertainment system 105 via a barcode 115. The example barcode 115 may be a two-dimensional barcode, as illustrated in FIG. 1, or a one-dimensional barcode. As shown in FIG. 1, the barcode 115 may be printed on a piece of paper 121, a boarding pass, an itinerary, etc., or displayed on an electronic device 122 such as a handheld computer, a laptop, a smartphone, a game console, a netbook, a tablet computer, an electronic book reader, a camera, etc. The barcode 115 may be generated by the passenger by using or accessing a barcode server 125 or a barcode generator 126 of the in-flight entertainment system 105. Thus, the barcode 115 can be used to convey passenger preference data and passenger-specific information from ground to aircraft and from aircraft to aircraft.

In general, barcodes optically or graphically represent or convey data intended for consumption by an electronic device equipped with an optical reader, camera, or scanner. Even though electronic device(s) produce and consume the data conveyed by a barcode, the actual transfer of the data is optical rather than electrical (wired or wireless). While conventional one and two-dimensional barcodes are used in examples disclosed herein, it should be appreciated that any other form of graphical, symbolic, easily reproducible, optically viewable, printable, and/or transportable medium could be used to convey passenger-specific information and passenger preference data. The barcode 115 can be created by the passenger on the ground either in the privacy of the passenger's home or place of business, at an airport, during check-in at a gate or, more generally, at any location at which the passenger has communicative access to the example barcode server 125 or the example barcode generator 126, which may include while the passenger is located in an aircraft. The barcode 115 can include a wide range of information that is entered, selected or approved by the passenger. Privacy is maintained by having the passenger choose or select what information is included in the barcode 115 and decide whether to scan the barcode 115. Accordingly, compared to present and previously contemplated systems, numerous advantages are realized by use of the barcode 115 to convey passenger preference data or passenger-specific information. For example, there is inherent device independence, barcodes are highly mobile and compact, and, because the barcode is machine-readable only (i.e., not understandable by humans), there is inherent security and privacy, etc.

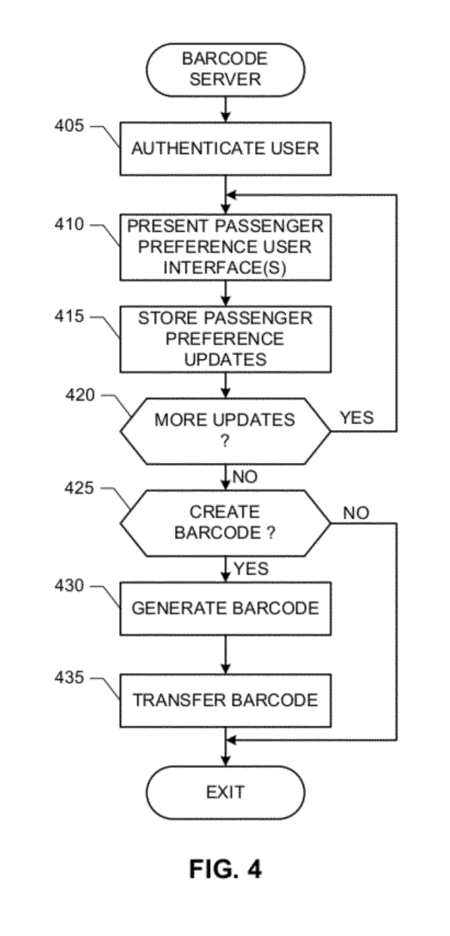

To enable a user to generate the barcode 115, the system 100 includes the example barcode server 125. The barcode server 125 may be any type of computer, server or workstation implementing a web-based interface accessible via a network such as the Internet 130. Accordingly, the barcode server 125 may be implemented by one or more Intel®, AMD®, or ARM® microprocessors (not shown). Of course, other processors from other processor families or manufacturers are also appropriate. The processor(s) executes coded instructions present in memory (not shown) of the barcode server 125, stored on a computer-readable storage device (not shown) such as a compact disc (CD), a digital versatile disc (DVD), a floppy disk, a FLASH drive, a hard disk drive, a network-attached storage device, a server-based storage device, etc. The processor(s) may execute, among other things, the example machine-readable instructions of FIG. 4.

The barcode server 125 provides one or more web-based user interfaces that enable a passenger to a) identify or authenticate herself, b) enter, select or choose passenger-specific information or passenger preferences, and c) generate a barcode including a representation of the entered, selected or chosen passenger-specific information or passenger preferences. The passenger may use any number or type(s) of electronic device(s) to access or utilize the barcode server 125. For example, the passenger may use a personal computer 135, workstation, a kiosk, an automated airline check-in terminal, a set-top box, a laptop, a netbook, or the handheld device 122 (e.g., a smartphone, a personal digital assistant (PDA), a game console, etc.) to access the barcode server 125.

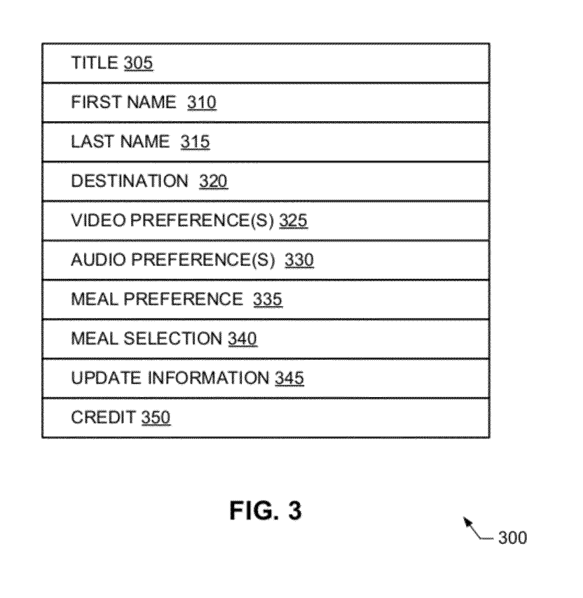

Based on the passenger-specific information or passenger preferences entered, selected or chosen by a passenger, the barcode server 125 generates the barcode 115. The barcode server 125 translates the passenger's selected information into alphanumeric codes based on information stored in a database 140. For example, the database 140 may identify that a first alphanumeric code is associated with jazz music, and a second alphanumeric code is associated with a particular movie. The barcode server 125 combines the alphanumeric codes to form a text string representing the passenger's selected information. The barcode server 125 graphically encodes the text string to form the barcode 115. In some examples, the text string may be encoded or encrypted prior to generation of the barcode 115 to enhance security. Example passenger preference data that may be included in the barcode 115 is described below in connection with FIG. 3. While not depicted in FIG. 1, a passenger may generate different barcodes 115 representing different sets of passenger selected information for different types of travel itineraries, different flights, different aircraft types, etc. While the barcode 115 may be associated with a particular seat assignment, flight or reservation, the information represented by the barcode 115 is independent of such ancillary information. That is, the barcode 115 may be used at any seat and on any flight regardless of its associated with a particular seat or flight.

The barcode server 125 provides the barcode 115 to the computer 135 or the handheld device 122. In the case of a computer (e.g., a non-portable computer), the barcode 115 may be printed on the paper 121, an itinerary or a boarding pass for transport. For example, a user interface presented at the computer 135 by the barcode server 125 may be used to print the barcode 115 on a printer (not shown) coupled to the computer 135. Alternatively, the barcode 115 may be stored in the handheld device 122 for subsequent transport, display and scanning. Further still, the barcode 115 may be electronically mailed to the passenger for subsequent transport, display and scanning on the handheld device 122 or any other device associated with the passenger. Even further, the computer 135 may display the barcode 115 on an associated display device to enable a passenger to take a photograph of the barcode using, for example, a digital camera or a smartphone including a digital camera.

Information may be stored in the database 140 using any number or type(s) of data structure(s), table(s) and database entry(-ies). The database 140 may be implemented using any number or type(s) of volatile and non-volatile memory(-ies), memory device(s) and storage device(s).

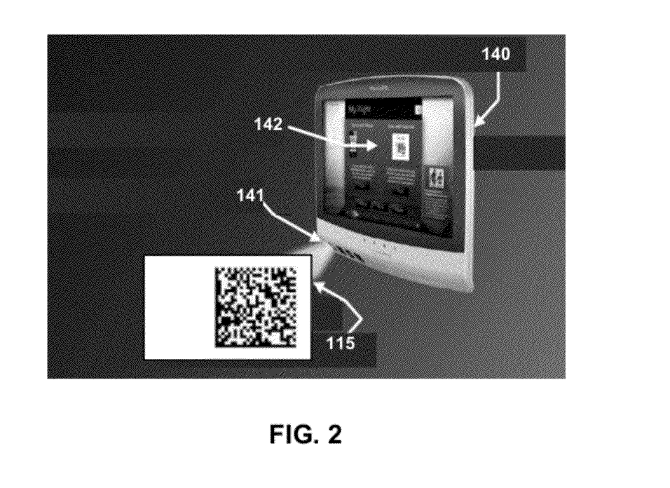

When a passenger reaches their seat in an airplane, they can provide their passenger-specific information or passenger preferences to the in-flight entertainment system 105 by optically scanning the barcode 115. In particular, the passenger uses an optical scanner 141 associated with an in-flight entertainment console 140 located in, for example, a seat back in front of the passenger. An example implementation of the in-flight entertainment console 140 is illustrated in FIG. 2.

In the illustrated example of FIG. 1, after the passenger activates the in-flight entertainment console 140 or authenticates himself to the in-flight entertainment console 140 via a display device such as a touch screen 142, the in-flight entertainment console 140 activates, turns on or enables the optical scanner 141. Alternatively, the barcode 115 may include information to identify or authenticate the passenger to the in-flight entertainment console 140. The barcode 115 may further include passenger account information such as billing account information, credit card information, travel award point information, drink coupon balance, travel upgrade balance, etc.

When the passenger holds the barcode 115 in front of the scanner 141 by either positioning the paper 121 or the handheld device 122 in front of the scanner 141, the example scanner 141 begins capturing images of the barcode 115. The scanner 141 may be a digital camera or webcam configured to capture in-focus images of close objects (i.e., objects placed 2 to 6 inches in front of the scanner 141). As shown in FIG. 2, the scanner 141 may be positioned at a downward angle for convenience and privacy. The scanner 141 may be configured to be severely out-of-focus at greater distances to provide further privacy. Moreover, the scanner 141 may include a passenger-operable cover to enable the passenger to manually enable and disable the scanner 141. The optical scanner 141 may be implemented as a module such as that described in U.S. patent application Ser. No. 13/109,143 filed on May 17, 2011, which is hereby incorporated by reference in its entirety.

To decode captured images of the barcode 115, the in-flight entertainment console 140 may include a decoder 143. Using any number or type(s) of method(s), logic and algorithm(s), the example decoder 143 attempts to decode the captured images of the barcode 115. In the absence of focus errors or decoding errors, the decoder 143 decodes at least one the captured images to obtain the text string generated by the barcode server 125. The decoder 143 may be implemented by executing machine-readable instructions on a processor such as a controller 144 of the in-flight entertainment console 140.

To parse the decoded text string to obtain the passenger-specific information or passenger preference data, the in-flight entertainment console 140 may include a parser 145. The example parser 145 parses the decoded text string into its constituent alphanumeric codes, and translates each of the constituent alphanumeric codes into corresponding passenger preference data by querying a database 150 hosted by an in-flight entertainment server 155. Alternatively, the database 150 may be implemented in conjunction with the in-flight entertainment console 140. The decoder 143 may be implemented by executing machine-readable instructions on the controller 144. Alternatively, the parser 145 may be implemented by the in-flight entertainment server 155.

Information may be stored in the database 150 using any number or type(s) of data structure(s), table(s) and database entry(-ies). The database 150 may be implemented using any number or type(s) of volatile and non-volatile memory(-ies), memory device(s) and storage device(s). The database 150 may be updated when an aircraft including the database 150 is at an airport, is being service, or is in flight via any number or type(s) of terrestrial, non-terrestrial, wired, wireless and satellite communication system(s). In contrast to prior art systems, the database 150 need not be populated with passenger-specific information or passenger preference data prior to the aircraft leaving the gate, taking off, or the passenger scanning their barcode 115.

The in-flight entertainment console 140 is communicatively coupled to the in-flight entertainment server 155 via a communication module 146 of the in-flight entertainment console 140 and an in-flight entertainment communication network 160. The in-flight entertainment console 140 may be communicatively couple to ground-based communication systems (not shown) via a terrestrial communication system (e.g., a wireless local area network, a cellular network) or a non-terrestrial communication system (e.g., a satellite communication system). For example, the terrestrial and non-terrestrial communication system(s) may be used to allow a passenger to make telephone calls and access the barcode server 125 via the Internet 130.

The in-flight entertainment console 140 may optionally include an additional communication module 147 such as a Bluetooth communication module or USB interface to enable the in-flight entertainment console 140 to communicate or transfer a barcode from the in-flight entertainment console 140 to an electronic device (e.g., the handheld device 122) associated with a passenger.

To control operation of the in-flight entertainment console 140, the in-flight entertainment console 140 includes the example controller 144. The controller 144 provides the decoded passenger-specific information or passenger preference data to the in-flight entertainment server 155. As appropriate, a portion of the decoded passenger-specific information or passenger preference data (e.g., meal preferences, drink selection, meal selections, etc.) may be forwarded by the in-flight entertainment server 155 to the crew 110.

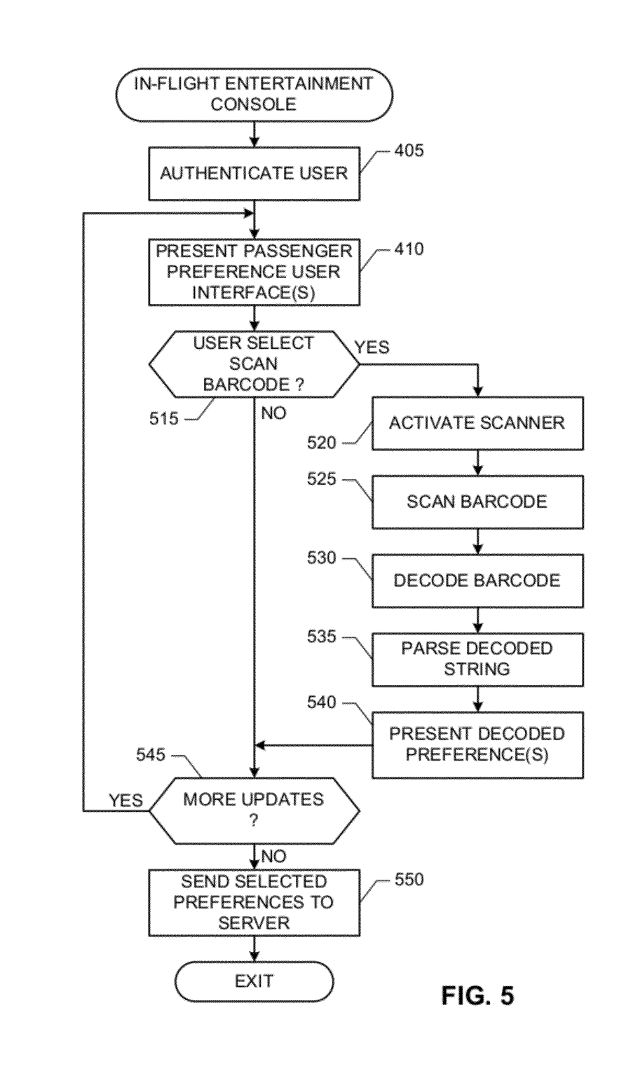

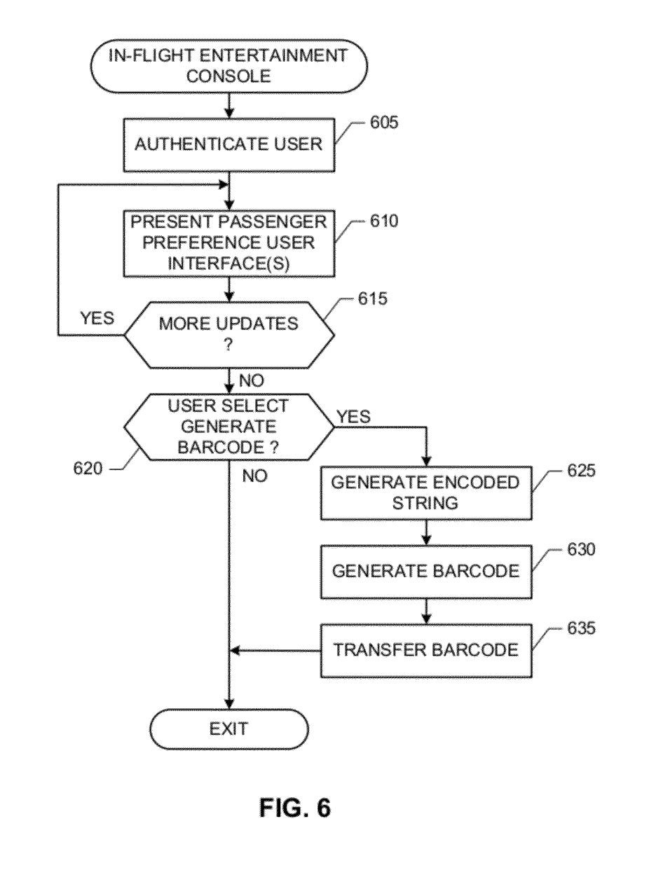

The controller 144 may be implemented by one or more Intel, AMD, or ARM microprocessors (not shown). Of course, other processors from other processor families and manufacturers are also appropriate. The controller 144 executes machine-readable instructions present in memory (not shown) of the controller 144, stored on a computer-readable storage device (not shown) such as a CD, a DVD, a floppy disk, a FLASH drive, a hard disk drive, a network-attached storage device, a server-based storage device, etc. The controller 144 may execute, among other things, the example machine-readable instructions that may be executed to perform the processes of FIGS. 5 and 6.

To generate barcodes such as the barcode 115, the in-flight entertainment console 140 includes the example barcode generator 126. The barcode generator 126 may implement substantially the same process(es) as the barcode server 125. Alternatively, the generator 126 may implement a web-based interface that enables the passenger to interact with the barcode server 125 via, for example, a terrestrial or a non-terrestrial communication system (e.g., a satellite communication system) to generate a barcode. For example, near the end of a flight, the passenger may utilize the barcode generator 126 to update their passenger-specific information or passenger preference data for a subsequent flight. For example, they may wish to record that they have watched half of a particular movie. Based on the updated passenger-specific information or passenger preference data, the barcode generator 126 generates another barcode 115 including a representation of the updated passenger-specific information or passenger preference data. The additional barcode 115 may, for example, be printed via an onboard printer (not shown) or electronically mailed to the passenger for subsequent use. Additionally or alternatively, the in-flight entertainment console 140 may display the additional barcode 115 generated by the barcode generator 126 on its display device 142 to enable a passenger to take a photograph of the barcode using, for example, a digital camera or a smartphone including a digital camera. The barcode generator 126 may be implemented by executing machine-readable instructions on the controller 144.

While, for ease of explanation and illustration, a single in-flight entertainment console 140 is depicted in FIG. 1, the in-flight entertainment system 105 typically includes multiple in-flight entertainment consoles 140. Moreover, a particular in-flight entertainment console 140 may be used to scan the barcodes 115 associated with more than one passenger. For example, when the in-flight entertainment console 140 is shared by multiple passengers.

One or more of the elements (e.g., interfaces, elements, devices, etc.) illustrated in FIG. 1 may be combined, divided, re-arranged, omitted, eliminated or implemented in any other way. Further, the elements shown in FIG. 1 may be implemented by one or more circuit(s), programmable processor(s), fuses, application-specific integrated circuit(s) (ASIC(s)), programmable logic device(s) (PLD(s)), field-programmable logic device(s) (FPLD(s)), field-programmable gate array(s) (FPGA(s)), etc. When any claim of this patent is read to cover a purely software implementation, at least one element of such an apparatus claim is hereby expressly defined to include a tangible machine-readable medium storing the software. Further still, the example system 100 may include elements instead of, or in addition to, those illustrated in FIG. 1. Moreover, the example system 100 may include more than one of any or all of the illustrated elements.

FIG. 2 illustrates an example manner of implementing the in-flight entertainment console 140 of FIG. 1. As shown in FIG. 2, the optical scanner 141 may be positioned at the bottom of the in-flight entertainment console 140 at a downward angle for convenience and privacy.

FIG. 3 illustrates example passenger-specific information and passenger preference data 300 that may be included in the barcode 115 of FIG. 1. To identify a passenger, the example data 300 includes a title field 305, a first name field 310 and a last name field 315. The example title field 305 includes one or more characters that represent a title such as Mr., Mrs. Dr., Rev., etc. The example first name field 310 and the last name field 315 include one or more characters that represent the passenger's first name and last name, respectively.

To optionally identify a final destination of a travel itinerary, the data 300 may include a destination field 320 including a three letter code (e.g., CHI, DFW, etc.) representing a destination airport.

To identify media preferences, the data 300 includes a video preferences field 325 and an audio preferences field 330. The example preferences fields 325 and 330 may include genre identifiers (e.g., rock, jazz, action, comedy) and identifiers for specific media (e.g., a specific movie or television show).

To identify meal preferences, the data 300 includes a meal preference field 335 and a meal selection field 340. The example meal preference field 335 includes one or more alphanumeric characters representing a meal type (e.g., kosher, low sodium, child, etc.). The example meal selection field 340 includes one or more alphanumeric characters representing a particular meal (e.g., continental, bacon and eggs, etc.).

To identify update location or update instructions, the example data 300 includes an optional update information field 345. The example update information field 345 includes one or more alphanumeric characters that represents, for example, a mobile telephone number to which an updated barcode could be sent, an electronic mail address to which an updated barcode could be sent, a default device identifiers representing a flight attendant printer, etc., or identifies a particular passenger seat.

To optionally identify account credit information, the example data 300 includes an optional credit field 350. The example credit field 350 includes one or more alphanumeric characters that represents, for example, available miles, account credit balance, drink coupons, etc. Information in the credit field 350 may be used, for example, to make purchases (e.g., food, beverage, movies, etc.) during a flight. The verification and subsequent accounting system updates of such information is beyond the scope of this disclosure. However, the barcodes disclosed herein may be used to convey such information to in-flight entertainment systems.

FIG. 4 is a flowchart of an example process that may be carried out to implement the example barcode server 125 of FIG. 1. The process of FIG. 4 may be implemented as machine-readable instructions executed by one or more processors to implement the example barcode server 125 of FIG. 1. The process of FIG. 4 begins with the barcode server 125 optionally authenticating a user (e.g., a passenger) based on, for example, a provided username and password (block 405). The barcode server 125 presents one or more user interfaces to enable the user to enter, select or choose passenger-specific information or passenger preference data (block 410). The barcode server 125 optionally stores the updated information for subsequent retrieval (block 415). If the user has more updates to make (block 420), control returns to block 410 to present one or more user interfaces.

If no more updates are needed (block 420) and if the user wants to generate a barcode (e.g., the barcode 115) (block 425), the barcode server 125 generates the barcode (block 430) and transfers the barcode by, for example, printing the barcode or electronically mailing the barcode (block 435). Control then exits from the example process of FIG. 4.

Returning to block 425, if the user does not want to generate a barcode (block 425), control exits from the example process of FIG. 4.

FIGS. 5 and 6 are flowcharts of example processes that may be carried out to implement the in-flight entertainment console 140 of FIG. 1. The processes of FIGS. 5 and 6 may be implemented as machine-readable instructions executed by one or more processors to implement the example in-flight entertainment console 140 of FIG. 1.

The process of FIG. 5 begins with the controller 144 authenticating the passenger based on, for example, a provided username and password (block 405). The controller 144 presents one or more user interfaces on the display 142 to enable the user to enter, select or choose passenger-specific information or passenger preference data (block 410). If the passenger indicates a barcode (e.g., the barcode 115) is to be scanned (block 515), the controller 155 activates the scanner 141 (block 520). The scanner 141 begins capturing images of the barcode (block 525) and the decoder 143 begins attempting to decode the captured images (block 530). When a captured image is successfully decoded, the parser 145 converts the decoded text string into passenger-specific information or passenger preference data (block 535). The controller 144 presents the decoded passenger-specific information or passenger preference data on the display 142 (block 540).

If the passenger has more updates to make (block 545), control returns to block 510 to present one or more user interfaces.

If no more updates are needed (block 545), the controller 144 sends the passenger's passenger-specific information or passenger preference data to the in-flight entertainment server 155 via the communication module 146 (block 550). Control then exits from the example process of FIG. 5.

Returning to block 515, if the user does not indicate a barcode is to be scanned (block 515), control proceeds to block 545 without capturing or decoding a barcode.

The process of FIG. 6 may be carried out at any time. Moreover, a passenger need not have previously scanned a barcode in order to utilize the example process of FIG. 6. Further still, the example processes of FIGS. 5 and 6 may be combined.

The example process of FIG. 6 begins with the controller 144 authenticating the passenger based on, for example, a provided username and password (block 605). The controller 144 presents one or more user interfaces on the display 142 to enable the user to enter, select or choose passenger-specific information or passenger preference data (block 610). If the passenger has more updates to make (block 615), control returns to block 610 to present one or more user interfaces.

When the passenger has completed their updates (block 615) and if the user indicates to generate an additional barcode (block 620), the generator 126 generates an encoded text string (block 625), generates the additional barcode (block 630), and transfers the barcode by, for example, printing the barcode or electronically mailing the barcode (block 635). Control then exits from the example process of FIG. 6.

Returning to block 620, if the user does not want to generate an additional barcode (block 620), control exits from the example process of FIG. 6.

A disclosed example method comprises:

operating a user interface to enable a passenger to generate a barcode including a representation of passenger preference data; and

operating an in-flight entertainment system in an airplane to enable the passenger to optically scan the barcode to provide the passenger preference data to the in-flight entertainment system.

The method as defined in paragraph [0070], further comprising operating the in-flight entertainment system to enable the passenger to optically scan the barcode while seated in a passenger seat of the airplane.

The method as defined in paragraph [0071], further comprising operating the in-flight entertainment system to enable the passenger to at least one of review, remove or modify the passenger preference data on a display device while seated in the passenger.

The method as defined in paragraph [0070], wherein the barcode includes a representation of at least one of passenger account data or passenger identification data.

The method as defined in paragraph [0070], wherein the barcode is independent of at least one of a passenger, a seat assignment, a flight or a reservation.

The method as defined in paragraph [0070], further comprising:

decoding the barcode to obtained decoded passenger preference data; and

providing the decoded passenger preference data to the in-flight entertainment system without communicating with a ground-based server during the decoding.

The method as defined in paragraph [0070], further comprising operating the in-flight entertainment system to provide a portion of the passenger preference data to a crew member.

The method as defined in paragraph [0070], wherein the passenger preference data represents at least one of a movie, an audio program, a television program, a language, a drink preference, or a food preference.

The method as defined in paragraph [0070], wherein generating the barcode comprises printing the barcode on a piece of paper.

The method as defined in paragraph [0070], wherein generating the barcode comprises communicating the barcode to a handheld electronic device associated with the passenger.

The method as defined in paragraph [0070], wherein generating the barcode comprises electronic mailing the barcode to the passenger.

The method as defined in paragraph [0070], wherein the user interface comprises a web-based interface.

The method as defined in paragraph [0070], wherein the user interface is accessible to the passenger while located in the airplane to enable the user to create a second barcode including a representation of second passenger preference data.

The method as defined in paragraph [0070], wherein the barcode is not human readable.

The method as defined in paragraph [0070], wherein the barcode comprises at least one of a one-dimensional barcode or a two-dimensional barcode.

The method as defined in paragraph [0070], wherein the passenger preference data is not transferred to the airplane via any communication system operated by any person employed by an airline.

The method as defined in paragraph [0070], wherein the passenger preference data is not transferred to the in-flight entertainment system prior to the passenger optically scanning the barcode.

A disclosed example system herein comprises:

a server to enable a passenger to generate a barcode including a representation of passenger preference data; and

an in-flight entertainment system including a scanner to enable the passenger to optically scan the barcode to provide the passenger preference data to the in-flight entertainment system.

The system as defined in paragraph [0087], further comprising an in-flight entertainment system console at a passenger seat of an aircraft that includes the scanner.

The system as defined in paragraph [0088], wherein the in-flight entertainment system console includes a display device to enable the passenger to at least one of review, remove, or modify the passenger preference data.

The method as defined in paragraph [0087], wherein the in-flight entertainment system includes a barcode generator to generate a second barcode including a representation of second passenger preference data.

The system as defined in paragraph [0087], wherein the barcode comprises at least one of a one-dimensional barcode or a two-dimensional barcode.

The system as defined in paragraph [0087], wherein the passenger preference data is not transferred to the in-flight entertainment system other than by optically scanning the barcode.

A disclosed example apparatus comprises:

a user interface to enable an airline passenger to provide passenger preference data; and

a barcode generator to generate a barcode including a representation of the passenger preference data, the barcode optically scannable by the passenger within an airplane to provide the passenger preference data to an in-flight entertainment system of the airplane.

The apparatus as defined in paragraph [0093], wherein the barcode is independent of at least one of a passenger, a seat assignment, a flight or a reservation.

The apparatus as defined in paragraph [0093], wherein a barcode generator is to print the barcode on a piece of paper.

The apparatus as defined in paragraph [0093], wherein the barcode generator is to transfer the barcode to a handheld electronic device associated with the passenger.

The apparatus as defined in paragraph [0093], wherein the barcode generator is to electronic mail the barcode to the passenger.

The apparatus as defined in paragraph [0093], wherein the user interface comprises a web-based interface.

The apparatus as defined in paragraph [0093], wherein the user interface is accessible to the passenger while located in the airplane to enable the user to create a second barcode including a representation of second passenger preference data.

Another disclosed example method comprises:

presenting a user interface to enable an airline passenger to provide passenger preference data; and

generating a barcode including a representation of the passenger preference data, the barcode optically scannable by the passenger within an airplane to provide the passenger preference data to an in-flight entertainment system of the airplane.

The method as defined in paragraph [00100], wherein the barcode is independent of at least one of a passenger, a seat assignment, a flight or a reservation.

The method as defined in paragraph [00100], further comprising printing the barcode on a piece of paper.

The method as defined in paragraph [00100], further comprising communicating the barcode to a handheld electronic device associated with the passenger.

The method as defined in paragraph [00100], further comprising electronically mailing the barcode to the passenger.

The method as defined in paragraph [00100], wherein the user interface comprises a web-based interface.

A disclosed example tangible article of manufacture stores machine-readable instructions that, when executed, cause a machine to at least:

present a user interface to enable an airline passenger to provide passenger preference data; and

generate a barcode including a representation of the passenger preference data, the barcode optically scannable by the passenger within an airplane to provide the passenger preference data to an in-flight entertainment system of the airplane.

The article of manufacture as defined in paragraph [00106], wherein the barcode is independent of at least one of a passenger, a seat assignment, a flight or a reservation.

The article of manufacture as defined in paragraph [00106], wherein the machine-readable instructions, when executed, cause the machine to print the barcode on a piece of paper.

The article of manufacture as defined in paragraph [00106], wherein the machine-readable instructions, when executed, cause the machine to communicate the barcode to a handheld electronic device associated with the passenger.

The article of manufacture as defined in paragraph [00106], wherein the machine-readable instructions, when executed, cause the machine to electronically mail the barcode to the passenger.

The article of manufacture as defined in paragraph [00106], wherein the user interface comprises a web-based interface.

The embodiments described herein may include a tangible machine-readable storage device for storing machine-readable instructions, a processor for executing the machine-readable instructions, a permanent storage such as a disk drive, a communications port for handling communications with external devices, and user interface devices, including a display, keys, etc. When software modules are involved, these software modules may be implemented as machine-readable instructions, which are executable by one or more processors, stored on a tangible article of manufacture such as a tangible machine-readable storage media. Example machine-readable storage media include a read-only memory (ROM), a random-access memory (RAM), a CD, a DVD, a magnetic tape, a floppy disk, an optical data storage device, an electronic storage media (e.g., an integrated circuit (IC), an electronically erasable programmable read-only memory (EEPROM), a flash memory, etc.), a quantum storage device, a cache, or any other storage media in which information may be stored for any duration (e.g., for extended time periods, permanently, brief instances, for temporarily buffering, or for caching of the information). The machine-readable storage medium can also be distributed over network-coupled computer systems (e.g., a network-attached storage device, a server-based storage device, a shared network storage device, etc.) so that the machine-readable instructions may be stored and executed in a distributed fashion. As used herein, a machine-readable storage medium excludes any media on which signals may be propagated. However, a machine-readable storage medium may include internal signal traces or internal signal paths carrying electrical signals therein

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the disclosed examples, reference has been made to the embodiments illustrated in the drawings, and specific language has been used to describe these embodiments. However, no limitation of the scope of the claims of this patent is intended by this specific language, and the claims should be construed to encompass all embodiments that would normally occur to one of ordinary skill in the art in light of this disclosure.

The examples disclosed herein may be described in terms of functional block components and various processing steps. Such functional blocks may be realized by any number of hardware and software components configured to perform the specified functions. For example, the disclosed examples may employ various integrated circuit components, e.g., memory elements, processing elements, logic elements, look-up tables, and the like that may carry out a variety of functions under the control of one or more microprocessors or other control devices. Similarly, where disclosed elements may be implemented using software programming or software elements the disclosed examples may be implemented with any programming or scripting language such as C, C++, Java, extensible markup language (XML), hyper-text transfer protocol (HTTP), assembler, or the like, with the various algorithms being implemented with any combination of data structures, objects, processes, routines or other programming elements. Functional aspects may be implemented in algorithms that execute on one or more processors. Furthermore, the disclosed examples could employ any number of conventional techniques for electronics configuration, signal processing, control, data processing, and the like. The words “mechanism” and “element” are used broadly herein and are not limited to mechanical or physical embodiments, but can include software routines in conjunction with processors, etc.

The particular examples disclosed herein are illustrative examples and are not intended to otherwise limit the scope of the claims of this patent in any way. For the sake of clarity, conventional electronics, control systems, software development and other functional aspects of the systems (and components of the individual operating components of the systems) may not be illustrated or described in detail. Furthermore, the connecting lines, or connectors shown in the various figures presented are intended to represent exemplary functional relationships, and physical or logical couplings between the various elements. It should be noted that many alternative or additional functional relationships, physical connections or logical connections may be present in a practical device. Moreover, no item or component is essential to the practice of the disclosed embodiments unless the element is specifically described as “essential” or “critical”.

The use of the terms “a” and “an” and “the” and similar referents in the context of describing the disclosed examples (especially in the context of the following claims) are to be construed to cover both the singular and the plural. Furthermore, any recitation of ranges of values herein are merely intended to serve as a shorthand for referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as” or “for example”) provided herein, is intended merely to better illuminate the disclosed embodiments and does not pose a limitation on the scope of the claims unless otherwise claimed. Numerous modifications and adaptations will be readily apparent to those skilled in this art without departing from the spirit and scope of this disclosure.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

1. An airline passenger seat comprising:
an optical device to optically scan a barcode presented by a passenger associated with the airline passenger seat, the barcode generated by the passenger and including a representation of passenger preference data;
a display device to enable the passenger to review the passenger preference data; and
a communication module to provide the passenger preference data to an inflight entertainment system.

2. The airline passenger seat of claim 1, wherein the display device comprises a touch screen that enables the passenger to provide second passenger preference data.

3. The airline passenger seat of claim 1, further comprising a second communication module to provide to a handheld electronic device associated with the passenger a second barcode including a representation of second passenger preference data.

4. The airline passenger seat of claim 1, wherein the barcode is independent of at least one of a passenger, a seat assignment, a flight or a reservation.

5. The airline passenger seat of claim 1, further comprising a decoder to decode an image of the barcode without communicating with any groundbased server.

6. The airline passenger seat of claim 1, wherein the barcode comprises the barcode printed on a piece of paper.

7. The airline passenger seat of claim 1, wherein the barcode comprises the barcode displayed a handheld electronic device associated with the passenger.

8. The airline passenger seat of claim 1, further comprising a barcode generator to create a second barcode including a representation of second passenger preference data.

9. The airline passenger seat of claim 1, wherein the barcode is not human readable.

10. A method comprising:
optically scanning at a passenger seat a barcode presented by a passenger associated with the passenger seat, the barcode generated by the passenger and including a representation of passenger preference data;
presenting a user interface to enable the passenger to review the passenger preference data; and
communicating the passenger preference data to an in-flight entertainment system.

11. The method of claim 10, further comprising communicating to a handheld electronic device associated with the passenger a second barcode including a representation of second passenger preference data.

12. The method of claim 10, wherein the barcode is independent of at least one of a passenger, a seat assignment, a flight or a reservation.

13. The method of claim 10, further comprising decoding the barcode without communicating with any ground-based server.

14. The method of claim 10, wherein the barcode comprises at least one of the barcode printed on a piece of paper or the barcode displayed a handheld electronic device associated with the passenger.

15. The method of claim 10, further comprising generating a second barcode including a representation of second passenger preference data.

16. The method of claim 10, wherein the barcode is not human readable.

17. The method of claim 10, wherein the barcode comprises at least one of a one-dimensional barcode or a two-dimensional barcode.

18. A tangible article of manufacture storing machine-readable instructions that, when executed, cause a machine to at least:
optically scan at a passenger seat a barcode presented by a passenger associated with the passenger seat, the barcode generated by the passenger and including a representation of passenger preference data;
present a user interface to enable the passenger to review the passenger preference data; and
communicate the passenger preference data to an in-flight entertainment system.

19. The tangible article of manufacture of claim 18, wherein the barcode is independent of at least one of a passenger, a seat assignment, a flight, or a reservation.

20. The tangible article of manufacture of claim 18, wherein the machine-readable instructions, when executed, cause the machine to decode the barcode without communicating with any ground-based server.

21. The tangible article of manufacture of claim 18, wherein the barcode comprises at least one of the barcode printed on a piece of paper or the barcode displayed a handheld electronic device associated with the passenger.

22. The tangible article of manufacture of claim 18, wherein the machine-readable instructions, when executed, cause the machine to generate a second barcode including a representation of second passenger preference data.

23. The tangible article of manufacture of claim 22, wherein the machine-readable instructions, when executed, cause the machine to communicate to a handheld electronic device associated with the passenger the second barcode.

24. The tangible article of manufacture of claim 18, wherein the barcode is not human readable.

25. The tangible article of manufacture of claim 18, wherein the barcode comprises at least one of a one-dimensional barcode or a two-dimensional barcode.
